(19) United States
(12) Patent Application Publication
(10) Pub. No.: US 2003/0088979 A1
(43) Pub. Date: May 15, 2003

(54) Method of producing aluminum ball, method of producing compressor shoe, and compressor shoe produced by the method

(75) Inventors: Masanobu Tomita, Kariya-shi (JP); Hironobu Tsushima, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Kabushiki Kaisha Toyota Jidoshokki

(21) Appl. No.: 10/288,004

(22) Filed: Nov. 4, 2002

(30) Foreign Application Priority Data
Nov. 12, 2001 (JP) 2001-345754

(51) Int. Cl. B23P 15/00

(52) U.S. Cl. 29/888.02

(57) ABSTRACT

A method of producing an aluminum ball, comprising the steps of: a cutting step of cutting a bar-shaped blank formed of a material containing aluminum as a major component, into cut pieces; an aluminum-ball forming step of forming each of the cut pieces into the aluminum ball by semi-closed die forging, said aluminum ball having a flash formed on an outer circumferential surface thereof; and a flash removing step of removing the flash from the aluminum ball formed by forging. Also disclosed is a method of producing a shoe for a compressor, from the aluminum ball.

This application is based on Japanese Patent Application No. 2001-345754 filed Nov. 12, 2001, the contents of which are incorporated hereinto by reference.

### BACKGROUND OF THE INVENTION

1. Field of the Invention

The present invention relates in general to a method of producing an aluminum ball used as a blank for a shoe installed on a compressor, a method of producing a shoe for a compressor, using the aluminum ball, and a shoe for a compressor produced by the method.

Discussion of the Related Art

From the viewpoint of resource saving and energy saving, various operating members formed of metal materials are required to have reduced weights. In a swash plate type compressor used in an air-conditioning system of an automotive vehicle, which compressor is particularly required to have a reduced weight, it is proposed to use an aluminum alloy which contains aluminum as a major component, for forming a shoe as one component of the compressor. The shoe formed of the aluminum alloy is disclosed in JP-U-57-42180, for instance. The swash plate type compressor is adapted to compress a gas by converting a rotary movement of the swash plate into a reciprocating movement of a plurality of pistons. Between the swash plate which is rotated at a relatively high speed and each piston which is reciprocated at a relatively high speed, the shoe as a sliding member is disposed for permitting a smooth relative movement therebetween.

The shoe has sliding surfaces which are to be held in sliding contact with the swash plate and the piston, respectively. In operation, the shoe slides on both of the swash plate and the piston with lubricant oil films being formed between the sliding surfaces of the shoe and the sliding surfaces of the swash plate and the piston. Accordingly, suitable clearances need to be formed between the sliding surfaces of the shoe and the sliding surfaces of the swash plate and the piston. Therefore, the shoe is required to have a high degree of dimensional accuracy. In a conventional method of producing a compressor shoe, a bar-shaped member is initially cut into a plurality of pieces each used as a shoe blank having a predetermined length, and the cut pieces are subjected to plastic deformation so as to provide shoes each as a formed article. The bar-shaped member is prepared by first extruding a billet which is formed of an aluminum alloy and which is obtained by casting, and drawing the billet to provide the bar-shaped member having a predetermined diameter. Since the bar-shaped member needs to be cut into the plurality of pieces with high cutting accuracy to form the shoes having high dimensional accuracy, the bar-shaped member cannot be subjected to a high-speed cutting operation by shearing. In the conventional method, the bar-shaped member needs to be cut by a cutting device such as a saw, a high-pressure water jet, or a wire saw, into the plurality of pieces each having a predetermined length corresponding to a desired dimension of the shoe to be obtained, plus an amount of stock removal by a grinding operation to follow. The thus obtained cut pieces are subjected to the grinding operation, for thereby providing shoe blanks each having a constant height (length of cut) and a constant weight (volume). The shoe blanks are subjected to plastic deformation, so as to provide shoes each as a formed article. The conventional method, however, requires a relatively long time for cutting the bar-shaped member by the cutting device. Further, the pieces produced by cutting with the cutting device suffer from a variation in the height dimension, so that the cut pieces do not have a constant height with high accuracy. Accordingly, the height of the cut pieces needs to be accurately adjusted to a desired value in a subsequent grinding operation, undesirably making the process steps cumbersome. The conventional method requires the grinding machine in addition to the cutting device, inevitably pushing up an equipment cost and requiring a large installation space. Since the conventional method requires a relatively long time for conducting the cutting step and the grinding step, the production of a desired number of the shoe blanks within a required time requires the use of a relatively large number of devices for the production, which inevitably results in a comparatively large dimensional variation of the produced shoe blanks. Thus, it is difficult to obtain the shoe blanks having high dimensional accuracy with high stability.

### SUMMARY OF THE INVENTION

It is therefore an object of the present invention to produce, with high stability, an aluminum ball and a compressor shoe with high dimensional accuracy. This object may be achieved according to any one of the following modes of the present invention in the form of an aluminum ball, a method of producing an aluminum ball, a shoe for a compressor, and a method of producing a shoe for a compressor. Each of the following modes is numbered like the appended claims and depends from the other mode or modes, where appropriate, to indicate and clarify possible combinations of elements or technical features. It is to be understood that the present invention is not limited to the technical features or any combinations thereof which will be described for illustrative purpose only. It is to be further understood that a plurality of elements or features included in any one of the following modes of the invention are not necessarily provided all together, and that the invention may be embodied without some of the elements or features described with respect to the same mode.

(1) A method of producing an aluminum ball, comprising the steps of: a cutting step of cutting a bar-shaped blank formed of a material containing aluminum as a major component, into cut pieces; an aluminum-ball forming step of forming each of the cut pieces into the aluminum ball by semi-closed die forging, the aluminum ball having a flash formed on an outer circumferential surface thereof, and a flash removing step of removing the flash from the aluminum ball formed by forging.

In the method according to the above mode (1) wherein the aluminum ball is produced by semi-closed die forging, there is used a semi-closed die assembly which includes a pair of dies each having a die face in which an impression is formed. When the two dies are closed together, the impressions cooperate to define a cavity whose configuration corresponds to that of the aluminum ball to be obtained. The dies used in the semi-closed die forging are designed such that the respective die faces of the dies are not held in contact with each other, namely, spaced apart from each other, in at least respective portions thereof adjacent to the respective impressions, when the two dies are closed together. Accordingly, a space is formed between the die faces of the two dies at at least a position adjacent to the cavity. In this arrangement, the cavity formed when the two dies are closed has a constant volume with high accuracy. An excess material of the cut piece flows from the cavity into the space formed between the two dies. The excess material which flows into the space forms a flash or a burr on the surface of the forged aluminum ball. The thus formed flash is removed from the aluminum ball in the flash removing step. Therefore, the present method permits easy manufacture of the aluminum ball having predetermined constant dimensions and a predetermined weight. The bar-shaped member may include a round bar obtained by drawing, and a coil. In the method according to the above mode (1), it is not necessary to conduct the conventionally required additional step of grinding the cut piece to achieve the desired dimensional accuracy, resulting in an improvement in the production efficiency and a reduction of the cost of manufacture of the aluminum ball. Further, the present method does not require the grinding device and the space for installing the grinding device. Therefore, the present method reduces a required space for installation of the production equipment. Moreover, the semi-closed die forging described above permits easy control of the dimensions and the weight of the aluminum ball to be produced, so that the produced aluminum ball has predetermined constant dimensions and a predetermined constant weight.

While the aluminum ball may be forged in a hot or a cold state, it is preferable to employ cold forging. In general, the article obtained by the cold forging has a high degree of dimensional accuracy and a good surface condition. Further, the cold forging can be conducted in a simplified and economical manner without heating.

(2) A method according to the above mode (1), wherein the cutting step comprises cutting the bar-shaped blank by shearing.

Since the space formed between the two dies when the two dies are closed together is effective to absorb or accommodate a variation in the amount of the material of the cut piece, it is not necessary to cut the bar-shaped member with high accuracy. Therefore, the bar-shaped member can be subjected to a high-speed cutting operation by shearing. Thus, the method according to the above mode (2) permits mass production of the aluminum ball at a high speed, resulting in increased production efficiency.

(3) A method according to the above mode (1) or (2), further comprising a grinding step of grinding a surface of the aluminum ball, the grinding step being conducted after the flash removing step.

The grinding step conducted on the aluminum ball after the flash-removing step improves the surface condition of the aluminum ball and increases, as needed, the dimensional accuracy of the aluminum ball.

(4) An aluminum ball produced by a method comprising the steps of: a cutting step of cutting a bar-shaped blank formed of a material containing aluminum as a major component, into cut pieces; an aluminum-ball forming step of forming each of the cut pieces into the aluminum ball by semi-closed die forging, the aluminum ball having a flash formed on an outer circumferential surface thereof and a flash removing step of removing the flash from the aluminum ball formed by forging.

The method according to the mode (4) enjoys the advantages described above with respect to the above mode (1).

(5) An aluminum ball according to the above mode (4), which is used as a blank for producing a shoe used for a compressor.

The present invention was made to provide an aluminum ball suitably used as a blank for an aluminum shoe (hereinafter referred to as “aluminum shoe blank”). Accordingly, the aluminum ball provided by the present invention is particularly suitably used as the aluminum shoe blank. It is noted, however, that the aluminum ball produced by the present invention may be used for other applications where similar requirements (such as a requirement for high dimensional accuracy) are present.

(6) A method of producing a shoe used for a compressor, comprising the steps of: a cutting step of cutting a bar-shaped blank formed of a material containing aluminum as a major component, into cut pieces; an aluminum-shoe-blank forming step of forming, by semi-closed die forging, each of the cutting pieces into an aluminum shoe blank for the shoe, the aluminum shoe blank being generally spherical and having a flash formed on an outer circumferential surface thereof; a flash removing step of removing the flash from the aluminum shoe blank formed by forging; and shoe forming step of forming by forging the aluminum shoe blank into the shoe having a part-spherical crown shape, the shoe forming step being conducted after the flash removing step.

If the aluminum ball having high dimensional accuracy described above with respect to the above mode (1) is used as a blank for the aluminum shoe, the shoe having high dimensional accuracy can be easily produced from the aluminum shoe blank. Moreover, the process steps of producing the shoe can be simplified, for thereby improving the operating efficiency and the productivity of the shoe. The features according to the above modes (2) and (3) may be applicable to this mode (6).

(7) A method according to the above mode (6), further comprising a step of forming a covering film on a surface of the shoe obtained in the shoe forming step.

In the step of forming a covering film according to this mode (7), the covering film may be formed by covering the surface of the shoe (base body) with a suitable other material, or by modifying or processing the surface portion of the shoe (base body), for instance. In the former method, the covering film may be formed by plating of suitable metallic material or coating of suitable non-metallic material, for instance. By forming the covering film on the surface of the aluminum shoe, the shoe has a high coefficient of friction and improved sliding characteristics such as high resistances to seizure and wear. In particular where the shoe slides on a member (i.e., piston and swash plate) formed of a material that contains aluminum as a major component, the covering film formed on the surface of the aluminum shoe is effective to prevent seizure due to the sliding contact with the above-indicated member formed of a similar metallic (aluminum) material. Where the covering film is formed of a metal whose hardness is higher than the aluminum shoe (base body), the strength and wear resistance of the shoe are increased, resulting in an improvement in the durability of the shoe.

(8) A method according to the above mode (7), further comprising a heat-treating step of conducting a heat-treatment on the shoe, the heat-treating step being conducted between the shoe forming step and the step of forming a covering film.

The heat-treatment is conducted for the purpose of increasing the strength and the hardness of the aluminum shoe, for instance, and is also referred to as a thermal refining treatment. Described in detail, the thermal refining treatment includes, for instance, a T6 treatment according to Japanese Industrial Standard (JIS) H 0001, in which the blank as a precursor of the aluminum shoe is subjected to an artificial age hardening treatment after it has been subjected to a solution heat treatment, and a T7 treatment according to JIS H 0001, in which the blank as the precursor of the shoe is subjected to a stabilizing treatment which will be described, after it has been subjected to the solution heat treatment.

(9) A shoe for a compressor produced by a method comprising the steps of: a cutting step of cutting a bar-shaped blank formed of a material containing aluminum as a major component, into cut pieces; a forming step of forming, by semi-closed die forging, each of the cutting pieces into an aluminum shoe blank for the shoe, the aluminum shoe blank being generally spherical and having a flash formed on an outer circumferential surface thereof, a flash removing step of removing the flash from the aluminum shoe blank formed by forging; and a shoe forming step of forming by forging the aluminum shoe blank into the shoe.

This mode (9) enjoys the advantages described above with respect to the above mode (6).

### BRIEF DESCRIPTION OF THE DRAWINGS

The above and optional objects, features, advantages and technical and industrial significance of the present invention will be better understood and appreciated by reading the following detailed description of presently preferred embodiments of the invention, when considered in connection with the accompanying drawings, in which:

FIG. 1 is a front elevational view in cross section of a swash plate type compressor equipped with the shoes to which the principle of the present invention is applied;

FIG. 2 is an enlarged front elevational view in cross section of the shoe of FIG. 1;

FIG. 3 is a flow chart showing process steps for producing an aluminum ball according to one embodiment of the invention, the aluminum ball being used as a blank for the shoe;

FIG. 4 schematically shows some of the process steps in the flow chart of FIG. 3;

FIG. 5 is a flow chart showing process steps for producing a shoe for a compressor according to one embodiment of the invention, and for producing the shoe of FIG. 2; and

FIG. 6 is a front elevational view in cross section schematically showing the shoe forming step in the flow chart of FIG. 5.

### DETAILED DESCRIPTION OF THE PREFERRED EMBODIMENTS

Referring to the accompanying drawings, there will be described a presently preferred embodiment of this invention as applied to a shoe installed on a swash plate type compressor as a refrigerant compressor used for an air conditioning system of an automotive vehicle.

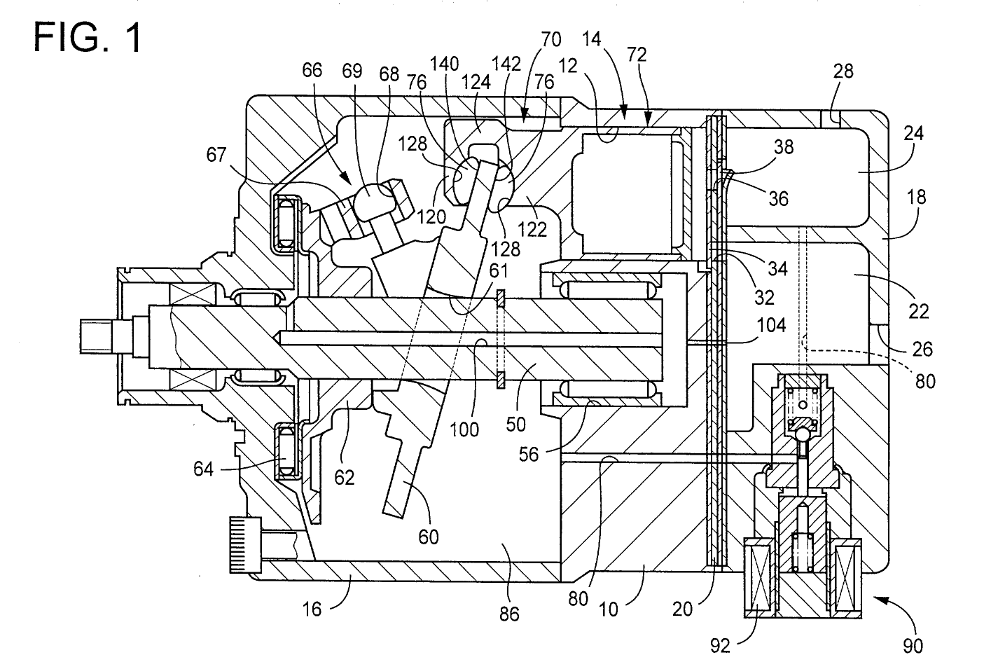

Referring first to FIG. 1, there is shown a compressor of swash plate type on which the shoe produced according to the present invention is installed. In FIG. 1, reference numeral 10 denotes a cylinder block having a plurality of cylinder bores 12 formed so as to extend in its axial direction such that the cylinder bores 12 are arranged along a circle whose center lies on a centerline of the cylinder block 10. Single-headed pistons' generally indicated at 14 (hereinafter simply referred to as “piston 14”) are reciprocably received in the respective cylinder bores 12. To one of the axially opposite end faces of the cylinder block 10, (the left end face as seen in FIG. 1, which will be referred to as' “front end face”), there is attached a front housing 16. To the other end face (the right end face as seen in FIG. 1, which will be referred to as “rear end face”), there is attached a rear housing 18 through a valve plate 20. The front housing 16, rear housing 18 and cylinder block 10 cooperate to constitute a housing assembly of the swash plate type compressor. The rear housing 18 and the valve plate 20 cooperate to define a suction chamber 22 and a discharge chamber 24, which are connected to a refrigerating circuit (not shown) through an inlet 26 and an outlet 28, respectively. The valve plate 20 has suction ports 32, suction valves 34, discharge ports 36 and discharge valves 38.

A rotary drive shaft 50 is disposed in the cylinder block 10 and the front housing 16 such that the axis of rotation of the drive shaft 50 is aligned with the centerline of the cylinder block 10. The drive shaft 50 is supported at its opposite end portions by the front housing 16 and the cylinder block 10, respectively, via respective bearings. The cylinder block 10 has a central bearing hole 56 formed in a central portion thereof, and the bearing is disposed in this central bearing hole 56, for supporting the drive shaft 50 at its rear end portion. The front end portion of the drive shaft 50 is connected, through a clutch mechanism such as an electromagnetic clutch, to an external drive source (not shown) in the form of an engine of an automotive vehicle. In operation of the compressor, the drive shaft 50 is connected through the clutch mechanism to the vehicle engine in operation so that the drive shaft 50 is rotated about its axis.

The rotary drive shaft 50 carries a swash plate 60 such that the swash plate 60 is axially movable and tiltable relative to the drive shaft 50. The swash plate 60 has a central hole 61 through which the drive shaft 50 extends. The inner dimension of the central hole 61 as measured in a vertical direction of FIG. 1 gradually increases in a direction from the axially intermediate portion toward each of the axially opposite ends, and the transverse cross sectional shape of the central hole 61 at each of the axially opposite ends is elongated. To the drive shaft 50, there is fixed a rotary member 62 as a torque transmitting member, which is held in engagement with the front housing 16 through a thrust bearing 64. The swash plate 60 is rotated with the drive shaft 50 by a hinge mechanism 66 during rotation of the drive shaft 50. The hinge mechanism 66 guides the swash plate 60 for its axial and tilting motions. The hinge mechanism 66 includes a pair of support arms 67 fixed to the rotary member 62, guide pins 69 which are formed on the swash plate 60 and which slidably engage guide holes 68 formed in the support arms 67, the central hole 61 of the swash plate 60, and the outer circumferential surface of the drive shaft 50.

The piston 14 indicated above includes an engaging portion 70 engaging the radially outer portion of the opposite surfaces of the swash plate 60, and a head portion 72 formed integrally with the engaging portion 70 and fitted in the corresponding cylinder bore 12. The head portion 72 in the present embodiment is made hollow, for thereby reducing the weight of the piston 14. The head portion 72, cylinder bore 12, and valve plate 20 cooperate with one another to define a pressurizing chamber. The engaging portion 70 engages the radially outer portion of the opposite surfaces of the swash plate 60 through a pair of part-spherical crown shoes 76. The shoes 76 will be described in greater detail. The piston 14 in the present embodiment has a single head portion 72 at one of its opposite ends, and is referred to as the single-headed piston.

A rotary motion of the swash plate 60 is converted into a reciprocating linear motion of the piston 14 through the shoes 76. A refrigerant gas in the suction chamber 22 is sucked into the pressurizing chamber of the cylinder bore 12 through the suction port 32 and the suction valve 34, when the piston 14 is moved from its upper dead point to its lower dead point, that is, when the piston 14 is in the suction stroke. The refrigerant gas in the pressurizing chamber is pressurized by the piston 14 when the piston 14 is moved from its lower dead point to its upper dead point, that is, when the piston 14 is in the compression stroke. The pressurized refrigerant gas in the pressurizing chamber is discharged into the discharge chamber 24 through the discharge port 36 and the discharge valve 38. A reaction force acts on the piston 14 in the axial direction as a result of compression of the refrigerant gas in the pressurizing chamber. This compression reaction force is received by the front housing 16 through the piston 14, swash plate 60, rotary member 62 and thrust bearing 64.

The cylinder block 10 has an intake passage 80 formed therethrough for communication between the discharge chamber 24 and a crank chamber 86 which is defined between the front housing 16 and the cylinder block 10. The intake passage 80 is connected to a solenoid-operated control valve 90 provided to control the pressure in the crank chamber 86. The solenoid-operated control valve 90 includes a solenoid coil 92. The amount of electric current applied to the solenoid coil 92 is controlled depending upon the air conditioner load by a control device not shown constituted principally by a computer.

The rotary drive shaft 50 has a bleeding passage 100 formed therethrough. The bleeding passage 100 is open at one of its opposite ends to the central bearing hole 56, and is open at the other end to the crank chamber 86. The central bearing hole 56 communicates at its bottom with the suction chamber 22 through a communication port 104.

The present swash plate type compressor is of variable capacity type. By controlling the pressure in the crank chamber 86 by utilizing a difference between the pressure in the discharge chamber 24 as a high-pressure source and the pressure in the suction chamber 22 as a low pressure source, a difference between the pressure in the pressurizing chamber and the pressure in the crank chamber 86 is regulated to change the angle of inclination of the swash plate 60 with respect to a plane perpendicular to the axis of rotation of the drive shaft 50, for thereby changing the reciprocating stroke (suction and compression strokes) of the piston 14, whereby the displacement capacity of the compressor can be adjusted. Described in detail, by energization and de-energization of the solenoid coil 92 of the solenoid-operated control valve 90, the crank chamber 86 is selectively connected to and disconnected from the discharge chamber 24, so that the pressure in the crank chamber 86 is controlled. The swash plate inclination angle changing device for changing the inclination angle of the swash plate in the present embodiment is constituted by the hinge mechanism 66, cylinder bores 12, pistons 14, suction chamber 22, discharge chamber 24, central bearing hole 56, crank chamber 86, bleeding passage 100, communication port 104, control device not shown, etc.

The cylinder block 10 and each piston 14 are formed of an aluminum alloy. The piston 14 is coated at its outer circumferential surface with a fluoro resin film which prevents a direct contact of the aluminum alloy of the piston 14 with the aluminum alloy of the cylinder block 10 so as to prevent seizure therebetween, and makes it possible to minimize the amount of clearance between the piston 14 and the cylinder bore 12. Other materials may be used for the cylinder block 10, the piston 14, and the coating film.

The end portion of the engaging portion 70 of the piston 14, which is remote from the head portion 72, has a U-shape in cross section. Described in detail, the engaging portion 70 has a base section 124 which defines the bottom of the U-shape, and a pair of substantially parallel arm sections 120, 122 which extend from the base section 124 in a direction perpendicular to the axis of the piston 14. The two opposed lateral walls of the U-shape of the engaging portion 70 have respective recesses 128 which are opposed to each other. Each of these recesses 128 is defined by a part-spherical inner surface of the lateral wall. The part-spherical inner surfaces of the recesses 128 are located on the same spherical surface.

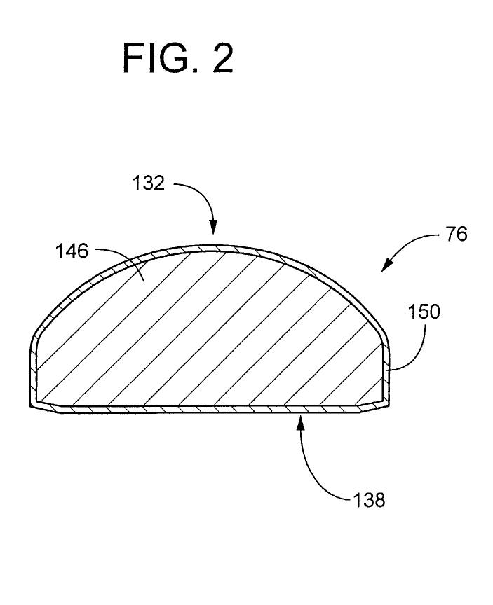

As shown in FIG. 2, each of the pair of shoes 76 has a substantially part-spherical crown shape, and includes a generally convex part-spherical surface 132 and a generally flat surface 138. The flat surface 138 is a slightly convex curved surface (e.g., a convex part-spherical surface having a considerably large radius of curvature), and includes a tapered portion formed at a radially outer portion thereof. The part-spherical surface 132 has a cylindrical portion formed adjacent to the flat surface 138. The boundary between the convex curved surface and the tapered portion, the boundary between the tapered portion and the cylindrical portion, and the boundary between the cylindrical portion and the part-spherical convex surface, are rounded so as to have respective different small radii of curvature. The pair of shoes 76 slidably engage the part-spherical inner surfaces of the recesses 128 of the piston 14 at their part-spherical surfaces 138 and slidably engage the radially outer portion of the opposite surfaces of the swash plate 60, i.e., sliding surfaces 140, 142 of the swash plate 60, at their flat surfaces 138. The pair of shoes 76 are designed such that their convex part-spherical surfaces 132 are located on the same spherical surface. In other words, each shoe 76 has a part-spherical crown shape whose size is smaller than a hemi-sphere by an amount corresponding to a half of the thickness of the swash plate 60. The shape of the shoe is not limited to that described above. For instance, the shoe used for a compressor of fixed capacity type desirably has a size slightly larger than the hemi-sphere for preventing a reduction in the sliding surface area even when the flat portion of the shoe is worn.

The shoe 76 includes a base body 146 and a covering film 150 which is formed so as to cover the surface of the base body 146. In FIG. 2, the thickness of the covering film 150 is exaggerated for easier understanding. The base body 146 is formed of an Al—Si alloy, i.e., A4032 according to JIS H 4100, which contains aluminum as a major component, and silicon. Various kinds of aluminum alloy can be used as the material for the base body 146 of the present shoe 76. The covering film 150 in the present embodiment is formed of a metal plating in the form of an electroless nickel plating which may be selected from Ni—P plating, Ni—B plating, Ni—P—B plating, and Ni—P—B—W plating, for instance. The covering film 150 formed of the electroless nickel plating exhibits high degrees of hardness and strength, for thereby preventing the wear of the shoe 76 while protecting the shoe 76 from being damaged or scratched. The covering film 150 may consist of a single film or a plurality of the same kind of or different kinds of films. The covering film 150 may cover the entire surface or a portion of the surface of the base body 146. The covering film 150 may be formed of a metal plating which contains a solid lubricant. Further, the covering film 150 may be covered with a lubricating film which contains the solid lubricant.

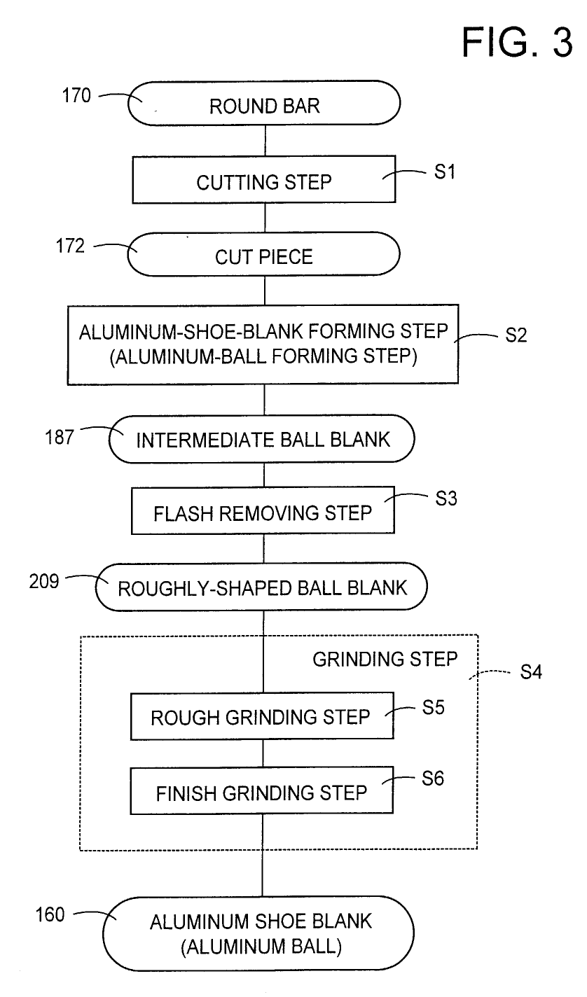

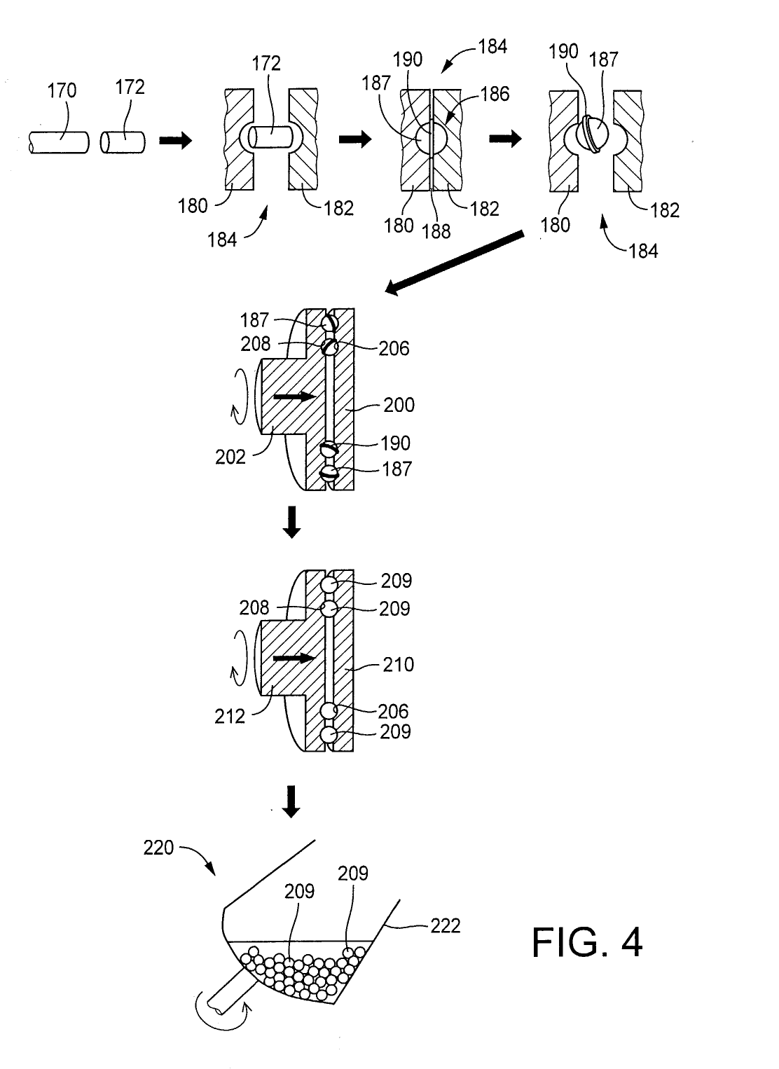

There will be next explained a method of producing the shoe 76 by referring to FIGS. 3-5. The base body 146 of the shoe 76 is produced from an aluminum shoe blank 160 having a spherical shape. (Hereinafter, the aluminum shoe blank 160 is simply referred to as “blank 160”.) FIG. 3 is a flow chart showing the process steps of producing the blank 160 while FIG. 4 schematically shows the process steps in the flow chart. The blank 160 is an aluminum ball having a spherical shape and formed of the above-described Al—Si alloy (A4032). For producing the blank 160 in the form of the aluminum ball, a bar-shaped member in the form of a round bar 170 is used. The bar-shaped member corresponds to a bar-shaped blank. The round bar 170 is prepared first by extruding a billet which is formed of an aluminum alloy having a selected composition and which is obtained by casting, and then drawing the billet to provide the round bar 170 having a predetermined diameter. The thus prepared round bar 170 is subjected to a cutting step S1 in which the round bar 170 is cut by shearing into a plurality of cut pieces 172 each having a predetermined length. The cut piece 172 has a generally cylindrical shape.

The cutting step S1 is followed by an aluminum-shoe-blank forming step (an aluminum-ball forming step) S2 in which each cut piece 172 is formed into a spherical shape by semi-closed die forging. The aluminum-shoe-blank forming step S2 is conducted by high-speed cold forging using a header, for instance. The semi-closed die forging is performed by using a forging device which includes a die assembly 184 including a pair of dies 180, 182 which are moved toward and away from each other. One of the pair of dies 180, 182 may be a stationary die while the other die may be a movable die. Alternatively, both of the dies 180, 182 may be movable dies. Each of the dies 180, 182 has a die face in which an impression is formed. When the two dies 180, 182 are closed together, the impressions cooperate to define a cavity 186 having a configuration and dimensions corresponding to those of the blank 160. The dies 180, 182 used in the semi-closed die forging are designed such that the die faces of the dies 180, 182 are spaced apart from each other in at least respective portions thereof adjacent to the respective impressions, when the two dies 180, 182 are closed together. Accordingly, a space 188 is formed between the die faces of the two dies 180, 182 at at least a position adjacent to the cavity 186. The dies 180, 182 are closed together with the cut piece 172 being set in one of the dies 180, 182, whereby the cut piece 172 is subjected to plastic deformation, and formed into an intermediate ball blank 187. An excess material of the cut piece 172, in other words, an extra amount of the material of the cut piece 172 which is not required to form the blank 160 having a desired weight (volume), flows from the cavity 186 into the space 188 formed as described above. Accordingly, the extra material forms an annular flash 190 on the outer circumferential surface of the intermediate ball blank 187. The intermediate ball blank 187 has substantially the same configuration and dimensions as those of the blank 160, except for the flash 190 formed on the intermediate ball blank 187. The above-described space 188 absorbs or accommodates a variation in the amount of the material of the cut piece 172, so that the intermediate ball blank 187 can be forged with high dimensional accuracy.

The aluminum-shoe-blank forming step S2 is followed by a flash removing step S3 in which the flash 190 formed on the intermediate ball blank 187 is removed by a flash removing device. The flash removing device used in the present embodiment includes a pair of cast iron discs (200, 202) as shown in FIG. 4. Since the flash removing device is known in the art, the structure of the device is briefly described. The pair of cast iron discs consists of a stationary disc 200 and a rotary disc 202. In major surfaces of the two discs 200, 202 which are opposed to each other, a plurality of grooves 206, 208 are formed, respectively, so as to extend in the circumferential direction of the two discs 200, 202. In FIG. 4, two of the plurality of grooves 206 formed on the major surface of the stationary disc 200 and two of the plurality of grooves 208 formed on the major surface of the rotary disc 202 are shown. The grooves 206 and the grooves 208 are concentric with one another. Each groove 206, 208 has a substantially semi-circular shape in transverse cross section. A plurality of intermediate ball blanks 187 flow into circumferentially extending part-annular spaces defined by the grooves 206 and the grooves 208, from inlet passages connected to the respective grooves 206 at one of circumferentially opposite ends thereof. With the intermediate ball blanks 187 being fitted in the part-annular spaces, the rotary disc 202 is rotated relative to the stationary disc 200, so that the intermediate ball blanks 187 are rolled while being pressed against the stationary disc 200. Accordingly, the intermediate ball blanks 187 are rubbed together or rubbed between the surfaces of the grooves 206 and the grooves 208, so that the flashes 190 formed on the intermediate ball blanks 187 are removed. Subsequently, the intermediate ball blanks 187 flow out of the part-annular spaces via outlet passages connected to the respective grooves 206 at the other of circumferentially opposite ends thereof, into a guide passage provided separately from the stationary disc 200. The intermediate ball blanks 187 are transferred by the guide passage, and again flow into the part-annular spaces defined by the grooves 206 and the grooves 208 via the inlet passages. Although the inlet passages, the outlet passages, and the guide passage are not shown, a brief explanation of which will be given. Each groove 206 formed in the stationary disc 200 is a part-annular groove without extending over the entire circumference of the stationary disc 200. One of the circumferentially opposite ends of each part-annular groove 206 is held in communication with an opening of the corresponding one of the outlet passages while the other circumferential end is held in communication with an opening of the corresponding one of the inlet passages. The number of the inlet passages and the number of the outlet passages are equal to that of the grooves 206. The outlet passages are connected to the inlet passages via the guide passage. The guide passage extends along an arc whose circumferential length is not smaller than a half of the entire circumference, and has a width dimension which permits the intermediate ball blanks 187 which have flowed out of the grooves 206 via the outlet passages, to be transferred while being held in substantially straight rows substantially parallel to the width direction of the guide passage. The outlet passages, the guide passage, and the inlet passages are arranged such that the radially outer outlet passages communicating with the radially outer grooves 206 are connected through the radially outer portion of the guide passage to the radially inner inlet passages communicating with the radially inner grooves 206. Described more specifically, the intermediate ball blanks 187 which flow into the radially outermost outlet passage from the radially outermost groove 206 are moved along the radially outermost portion of the guide passage, and flow into the radially innermost groove 206 via the radially innermost inlet passage. The intermediate ball blanks 187 which flow into the radially innermost outlet passage from the radially innermost groove 206 are moved along the radially innermost portion of the guide passage, and flow into the radially outermost groove 206 via the radially outermost inlet passage. Thus, the intermediate ball blanks 187 alternately flow through the radially inner part-annular spaces defined by the radially inner grooves 206, 208, and the radially outer part-annular spaces defined by the radially outer grooves 206, 208, so that the intermediate ball blanks 187 are repeatedly rubbed together, resulting in uniform removal of flashes therefrom. The flash removing operation described above continues for a long period of time, whereby the intermediate ball blank 187 is formed into a roughly-shaped ball blank 209 without the flash 190.

The roughly-shaped ball blank 209 obtained after the flash removing step S3 described above is subjected to a grinding step S4 in which the surface of the roughly-shaped ball blank 209 is ground. The grinding step S4 includes a rough grinding step S5 and a finish grinding step (roll grinding step) S6. In the rough grinding step S5, there is used a grinding device which includes a stationary disc 210 and a rotary disc 212 which are similar in construction to the stationary disc 200 and the rotary disc 202 used in the flash removing step S3 described above. The same reference numerals as used for the stationary and rotary discs 200, 202 used in the flash removing step S3 will be used to identify the corresponding components of the stationary and rotary discs 210, 212 used in the rough grinding step S5, which discs 210, 212 will not be explained in detail. In the rough grinding step S5, the surface of the roughly-shaped ball blank 209 is ground by using abrasive grains, so that the roughly-shaped ball blank 209 has improved dimensional accuracy and surface smoothness.

In the following finish grinding step S6, the surface of the roughly-shaped ball blank 209 is smoothed, so that the sphericity of the roughly-shaped ball blank 209 is controlled to be less than 0.003 mm in diameter (Φ0.003 mm). One example of the grinding device used in the finish grinding step S6 is a rotary grinding machine 220 shown in FIG. 4. The rotary grinding machine 220 includes a main body in the form of a container 222 in which a cleaning liquid is stored. A plurality of the roughly-shaped ball blanks 209 which have been subjected to the rough grinding step S5 are put into the cleaning liquid accommodated in the container 222. In this state, the rotary grinding machine 220 is actuated so that the roughly-shaped ball blanks 209 are held in rolling contact with one another, whereby the surfaces of the roughly-shaped ball blanks 209 are ground while foreign matters such as the abrasive grains used in the grinding operation described above or cutting chips remaining on the surfaces of the roughly-shaped ball blanks 209 are removed from the surfaces of the roughly-shaped ball blanks 209. Thus, the roughly-shaped ball blanks 209 which have been subjected to the grinding step S4 (including the rough grinding step S5 and the finish grinding step S6) are formed into the blanks 160 each in the form of the aluminum ball having a smooth surface and a high dimensional accuracy.

In producing the blank 160, a step of conducting an O-treatment according to JIS H 0001 may be conducted in addition to the above-described steps. The O-treatment is a heat-treatment, i.e., an annealing treatment, conducted for the purpose of reducing an internal stress of the blank 160. The O-treatment may be conducted at suitable different timings after the grinding step S4.

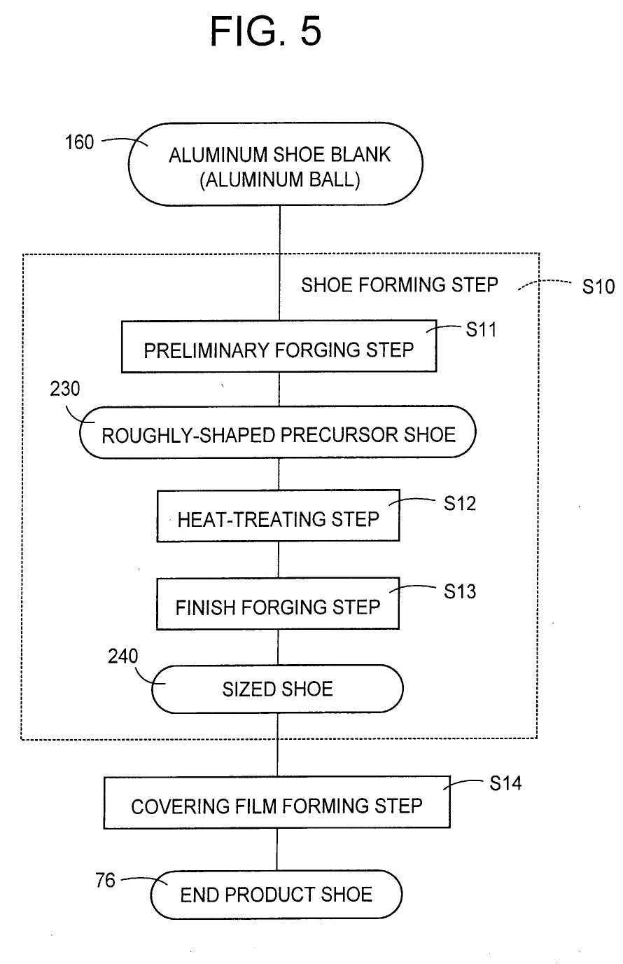

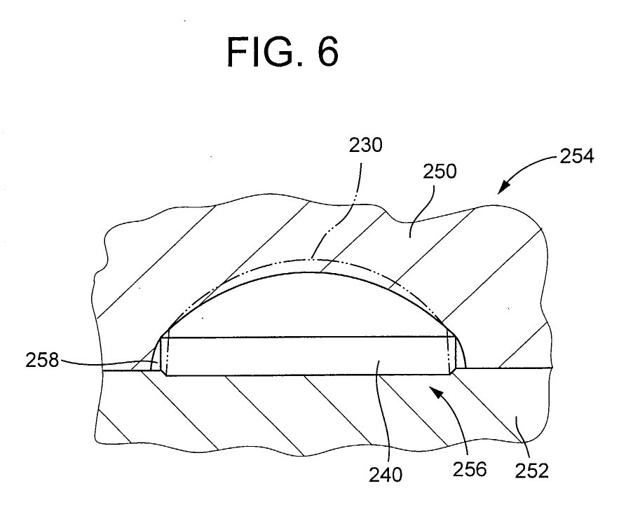

Next, there will be described a method of producing the shoe 76 from the blank 160 prepared as described above, by referring to FIG. 5 and FIG. 6. FIG. 5 is a flow chart indicating the process steps of producing the shoe 76. In a shoe forming step S10, the blank 160 prepared as described above is formed into the shoe 76. Described in detail, the shoe forming step S10 includes a preliminary forging step S11 and a finish forging step S13. In the present embodiment, a heat-treatment step S12 (thermal refining treatment) which will be described is conducted between the preliminary forging step S11 and the finish forging step S13. In the preliminary forging step S11, the blank 160 is forged into a roughly-shaped precursor shoe 230 (intermediate shoe) whose configuration is similar to that of the shoe 76 as an end product, by using a die assembly including a pair of dies, which is similar to the die assembly 184 described above. The shoe 76 is referred to as “end product shoe 76” where appropriate. In the present embodiment, the roughly-shaped precursor shoe 230 has a diameter smaller than that of the shoe 76 and a height larger than that of the shoe 76. In FIG. 6, the outline of the roughly-shaped precursor shoe 230 having a smaller diameter and a larger height than the shoe 76 is indicated by a two-dot chain line. The preliminary forging step S11 is also performed in a cold state.

In the following heat-treatment step S12, the roughly-shaped precursor shoe 230 is subjected to a thermal refining treatment. The thermal refining treatment is conducted immediately after the forging operation, in order to improve the characteristics (physical properties) of the aluminum alloy which constitutes the blank 160. For instance, the thermal refining treatment permits increased hardness and strength of the aluminum alloy. The heat-treatment conducted in the heat-treating step S12 of the present embodiment is a T6 treatment (according to JIS H 0001) in which the roughly-shaped precursor shoe 230 is subjected to an artificial age hardening treatment after it has been subjected to a solution heat treatment. In the solution heat treatment, the roughly-shaped precursor shoe 230 is kept in a heating furnace at around 500° C. for four hours, and then rapidly cooled down to room temperature, for instance. In the artificial age hardening treatment, the roughly-shaped precursor shoe 230 is kept in the heating furnace at around 170° C. for eight hours, for instance. The T6 treatment may be replaced with a T7 treatment (according to JIS H 0001) in which the roughly-shaped precursor shoe 230 which has been subjected to the solution heat treatment is subjected to an over-aging treatment which is effected beyond conditions of the artificial age hardening treatment at which the maximum strength is obtained. The over-aging treatment is also referred to as “stabilizing treatment”.

The roughly-shaped precursor shoe 230 which has been subjected to the heat-treatment is then subjected to the finish forging step S13 for sizing the roughly-shaped precursor shoe 230. Namely, in the finish forging step S13, the roughly-shaped precursor shoe 230 is forged into a sized shoe 240 whose configuration corresponds to that of the base body 146 of the end product shoe 76. The finish forging operation in this step S13 is conducted in a cold state by using a die assembly 254 which includes a pair of dies 250, 252 shown in FIG. 6. When the two dies 250, 252 are closed together with respective die faces being held in contact with each other, there is formed a cavity 256 having a configuration and a height following those of the base body 146 of the shoe 76. After the roughly-shaped precursor shoe 230 has been set in the stationary die 252, the movable die 250 is moved toward the stationary die 252, so that the two dies 250, 252 are closed together for forging the roughly-shaped precursor shoe 230 into the sized shoe 240. Described in detail, by closing the two dies 250, 252 together, the height of the roughly-shaped precursor shoe 230 is reduced while its diameter is increased, whereby the roughly-shaped precursor shoe 230 is forged into the sized shoe 240. The volume of the cavity 256 is made slightly larger than that of the sized shoe 240. In other words, the two dies 250, 252 are designed such that a space 258 is formed around the radially outer portion of the sized shoe 240 when the two dies 250, 252 are closed. The space 258 which is not filled with the material absorbs or accommodates a variation in the amount of the material, so that the obtained sized shoe 240 has the desired height with high accuracy. In addition, the obtained sized shoe 240 does not suffer from flashes. If the excess material flows into the space 258, the sized shoe 240 may suffer from slight variations in its configuration and dimension at its radially outer portion corresponding to the space 258. The radially outer portion of the sized shoe 240 corresponding to the space 258, however, is not held in sliding contact with any members when the end product shoe 76 (which is produced from the sized shoe 240) is installed on the compressor. Accordingly, the variations in the configuration and dimension at the radially outer portion of the sized shoe 240 do not matter. Like the die assembly 254 used in this finish forging step S13, the pair of dies used in the preliminary forging step S11 described above is also designed such that a space for absorbing a variation in the amount of the material is formed around the radially outer portion of the cavity when the two dies are closed, and a drawing and description of the pair of dies used in the preliminary forging step S11 are not given.

As described above, the shoe forming step is divided into a plurality of sub-steps (two in this embodiment). Described in detail, the blank 160 is forged into the roughly-shaped precursor shoe 230 having a configuration similar to that of the desired shoe 76 in the preliminary forging step S11, and the roughly-shaped precursor shoe 230 is subjected, after the thermal refining treatment, to the finish forging step S13, so as to provide the sized shoe 240 (corresponding to the base body 146 of the end product shoe 76). Accordingly, the end product shoe 76 to be produced from the sized shoe 240 has high dimensional accuracy.

The thus obtained sized shoe 240 (the base body 146) is then subjected to a step S14 of forming a covering film 150 on its surface, so that the entire surface of the base body 146 is covered with the covering film 150. Thus, the part-spherical crown shoe 76 as the end product shown in FIG. 2 is obtained. Even if hard foreign matters such as the abrasive grains or the cutting chips used or generated in the process steps of producing the blank remain on the surface of the sized shoe 240, those foreign matters are covered with the covering film 150 formed on the surface of the sized shoe in the step S14. Accordingly, the covering film 150 effectively prevents the foreign matters from being exposed while the end product shoe 76 slides on the piston 14 and the swash plate 60 during the operation of the compressor, whereby the sliding surfaces of the piston 14 and the swash plate 60 are prevented from being damaged by the foreign matters.

The method according to the present invention permits efficient production of the shoe 76 having high dimensional accuracy. In the conventional method described above in the BACKGROUND OF THE INVENTION, the amount of the shoe blanks produced in one lot is about 20,000. In contrast, it is confirmed that the amount of the shoe blanks produced in one lot according to the present method is about 300,000-500,000. In the conventional method wherein the cutting step and the grinding step are performed to produce the shoe blank, a large amount of cutting chips are inevitably generated. In the present method wherein the round bar 170 is cut by shearing, the cutting chips are prevented from being generated, so that the yield is improved by about 30%. In the conventional method, the cutting step requires about ten seconds per one shoe blank. In the present method, the cutting step S1 and the shoe blank forming step S2 require about 0.12 second per one shoe blank. In other words, about five hundred shoe blanks can be produced per one minute. Accordingly, the shoe 76 can be produced at a significantly high-speed, resulting in an improvement in the productivity of the shoe 76. In the conventional shoe blank, the amounts of variation in the height and weight are ±0.05 mm and ±50 mg, respectively. In contrast, the amounts of variation in the height and weight in the present shoe blank are as small as ±0.01 mm and ±5 mg, respectively. According to the present method, the blank 160 and the shoe 76 with high dimensional accuracy can be manufactured with high stability.

In the present embodiment, the aluminum shoe blank includes the intermediate ball blank 187 and the roughly-shaped ball blank 209. The aluminum shoe (the compressor shoe) includes the shoe 76, the base body 146 of the shoe 76, the roughly-shaped precursor shoe 230, and the sized shoe 240.

While the presently preferred embodiments of this invention have been described above, for illustrative purpose only, it is to be understood that the present invention is not limited to the details of the illustrated embodiments. For example, the principle of the invention is applicable to a shoe used for a swash plate type compressor equipped with a double-headed piston having head portions on the opposite sides of the engaging portion, or a shoe used for a swash plate type compressor of fixed capacity type. It is to be understood that the present invention may be embodied with various changes and improvements such as those described in the SUMMARY OF THE INVENTION, which may occur to those skilled in the art.

What is claimed is:

1. A method of producing an aluminum ball, comprising the steps of:
a cutting step of cutting a bar-shaped blank formed of a material containing aluminum as a major component, into cut pieces;
an aluminum-ball forming step of forming each of said cut pieces into said aluminum ball by semi-closed die forging, said aluminum ball having a flash formed on an outer circumferential surface thereof;
a flash removing step of removing said flash from said aluminum ball formed by forging.

2. A method according to claim 1, wherein said cutting step comprises cutting said bar-shaped blank by shearing.

3. A method according to claim 1, further comprising a grinding step of grinding a surface of said aluminum ball, said grinding step being conducted after said flash removing step.

4. An aluminum ball produced by a method comprising the steps of:
a cutting step of cutting a bar-shaped blank formed of a material containing aluminum as a major component, into cut pieces;
an aluminum-ball forming step of forming each of said cut pieces into said aluminum ball by semi-closed die forging, said aluminum ball having a flash formed on an outer circumferential surface thereof; and
a flash removing step of removing said flash from said aluminum ball formed by forging.

5. An aluminum ball according to claim 4, which is used as a blank for producing a shoe used for a compressor.

6. A method of producing a shoe used for a compressor, comprising the steps of:
a cutting step of cutting a bar-shaped blank formed of a material containing aluminum as a major component, into cut pieces;
an aluminum-shoe-blank forming step of forming, by semi-closed die forging, each of said cutting pieces into an aluminum shoe blank for said shoe, said aluminum shoe blank being generally spherical and having a flash formed on an outer circumferential surface thereof;
a flash removing step of removing said flash from said aluminum shoe blank formed by forging; and
a shoe forming step of forming by forging said aluminum shoe blank into said shoe having a part-spherical crown shape, said shoe forming step being conducted after said flash removing step.

7. A method according to claim 6, further comprising a step of forming a covering film on a surface of said shoe obtained in said shoe forming step.

8. A method according to claim 7, further comprising a heat-treating step of conducting a heat-treatment on said shoe, said heat-treating step being conducted between said shoe forming step and said step of forming a covering film.

9. A shoe for a compressor produced by a method comprising the steps of:
a cutting step of cutting a bar-shaped blank formed of a material containing aluminum as a major component, into cut pieces;
a forming step of forming, by semi-closed die forging, each of said cutting pieces into an aluminum shoe blank for said shoe, said aluminum shoe blank being generally spherical and having a flash formed on an outer circumferential surface thereof;;
a flash removing step of removing said flash from said aluminum shoe blank formed by forging; and
a shoe forming step of forming by forging said aluminum shoe blank into said shoe.
